(19) United States
(12) Patent Application Publication
(10) Pub. No.: US 2005/0210047 A1
(43) Pub. Date: Sep. 22, 2005

(54) Posting data to a database from non-standard documents using document mapping to standard document types

(75) Inventors: Bradford L. Hayes, Louisville, CO (US); Timothy E. Beres, Boulder, CO (US); Michael W. Diesch, Battle Creek, MI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zenodata Corporation, Louisville, CO (US)

(21) Appl. No.: 11/083,546

(22) Filed: Mar. 18, 2005

Related U.S. Application Data
(60) Provisional application No. 60/554,511, filed on Mar. 18, 2004.

(51) Int. Cl. G06F 7/00

(52) U.S. Cl. 707/100

(57) ABSTRACT

A method of populating a database includes receiving a plurality of document images, defining a plurality of standard document types, mapping each of the plurality of document images to one of the plurality of standard document types and processing each document image through a data extraction process. S specific document image's path through the data extraction process is based, at least in part, on the mapping and the data extraction process posts data from each document to the database. The method also includes receiving a request from a user for data contained in the database, selecting the data using the request, and displaying the selected data to the user.

### CROSS-REFERENCES TO RELATED APPLICATIONS

This application is a non-provisional of, and claims the benefit of, co-pending, commonly-assigned Provisional U.S. Patent Application No. 60/554,511, entitled “PROPERTY RECORDS DATABASES AND SYSTEMS AND METHODS FOR BUILDING AND MAINTAINING THEM” (Attorney Docket No. 040143-000100), filed on Mar. 18, 2004 the entirety of which is herein incorporated by reference for all purposes.

This application is related to the following co-pending, commonly-assigned U.S. patent applications, the entirety of each of which are herein incorporated by reference for all purposes: U.S. patent application Ser. No. ______, entitled “AUTOMATED POSTING SYSTEMS AND METHODS” (Attorney Docket No. 040143-000120US), filed on Mar. 18, 2005; U.S. patent application Ser. No. ______, entitled “CONFIDENCE-BASED CONVERSION OF LANGUAGE TO DATA SYSTEMS AND METHODS” (Attorney Docket No. 040143-000510US), filed on Mar. 18, 2005; U.S. patent application Ser. No. ______, entitled “CONTEXT-BASED CONVERSION OF LANGUAGE TO DATA SYSTEMS AND METHODS” (Attorney Docket No. 040143-000610US), filed on Mar. 18, 2005; U.S. patent application Ser. No. 10/804,472, entitled “AUTOMATED RECORD SEARCHING AND OUTPUT GENERATION RELATED THERETO” (Attorney Docket No. 040143-000200), filed on Mar. 18, 2004; U.S. patent application Ser. No. 10/804,468, entitled “DOCUMENT SEARCH METHODS AND SYSTEMS” (Attorney Docket No. 040143-000300), filed on Mar. 18, 2004; U.S. patent application Ser. No. 10/804,467, entitled “DOCUMENT ORGANIZATION AND FORMATTING FOR DISPLAY” (Attorney Docket No. 040143-000400), filed on Mar. 18, 2004; Provisional U.S. Patent Application No. 60/554,514, entitled “CONFIDENCE-BASED NATURAL LANGUAGE PARSING” (Attorney Docket No. 040143-000500), filed on Mar. 18, 2004; Provisional U.S. Patent Application No. 60/554,513, entitled “CONTEXTUAL CONVERSION OF LANGUAGE TO DATA” (Attorney Docket No. 040143-000600) filed on Mar. 18, 2004; U.S. patent application Ser. No. 10/876,250, entitled “EVALUATING THE RELEVANCE OF DOCUMENTS AND SYSTEMS AND METHODS THEREFOR” (Attorney Docket No. 040143-000700), filed on Jun. 23, 2004; U.S. patent application Ser. No. 10/966,155, entitled “TITLE QUALITY SCORING SYSTEMS AND METHODS” (Attorney Docket No. 040143-000800), filed on Oct. 14, 2004; U.S. patent application Ser. No. 10/966,154, entitled “TITLE EXAMINATION SYSTEMS AND METHODS” (Attorney Docket No. 040143-000900), filed on Oct. 14, 2004; and U.S. patent application Ser. No. 10/997,760, entitled “PRE-REQUEST TITLE SEARCHING SYSTEMS AND METHODS” (Attorney Docket No. 040143-001000), filed on Nov. 23, 2004.

### BACKGROUND OF THE INVENTION

Embodiments of the present invention relate generally to populating a database. More specifically, embodiments of the present invention relates to systems and methods for populating a database with data from non-standard documents by mapping each non-standard document to a standard document type.

The practice of recording real property transfers is well known. Local governments (e.g., counties) typically administer the recording system. Most any time a property owner transfers an interest in his property, a document evidencing the transfer is recorded in the county where the property is located, thus providing notice to others of who owns what interest in the property. The property owner may transfer all his right, for example, when an individual sells his primary residence, in which case a deed usually is recorded. In another example, a property owner may transfer only a right to foreclose on a mortgage if he does not make required payments, in which case a mortgage may be recorded. Those skilled in the art will appreciate other examples.

Before an entity (grantee) gives value in return for an interest in property, that entity typically desires to confirm that the property owner (grantor) has the right to transfer the interest. It is common practice for title companies to provide this confirmation in the form of “title policies.” Essentially an owner's title policy is an insurance policy that insures the grantee against the risk of receiving a defective interest in property. Before issuing a title policy, a title company physically searches recorded property records to create a chain of title and identify potential encumbrances to effective transfer of any of the bundle of rights associated with the subject property. Likewise, before a lender lends money secured by property, the lender typically searches the property records to assess the quality of the collateral. Such lenders purchase a loan policy to insure the lender against the risks of making a loan on a property with potential title problems. These are, of course, but two examples of instances in which searching property records is desirable, albeit probably the most common examples.

For a number of reasons, the process of searching property records is labor intensive. Property records typically are recorded in chronological order, not according to location, thus complicating the task of identifying recorded documents relating to a specific parcel from among the thousands of recorded documents. Further, any given parcel is a subdivided portion of a larger parcel and the property description is not consistent. Further still, a variety of documents are used to record transfers of property interests, and a standard format does not exist. Errors in recorded documents or in the indexing system used to locate the records further compound the problem. Probably most importantly, however, is the lack of an electronic searching system that includes all the information an underwriter may need to know about a parcel before issuing a policy or approving a loan relating to the property.

One of the barriers to creating an electronic searching system is the lack of an efficient system for converting documents—in some cases, hundreds of thousands of documents—to searchable records. It is impractical to parse every legal description by hand, and property records have extremely complex language, making electronic parsing extremely difficult. Consider, for example, a legal description on a deed. Numerous formats exist for describing a parcel, and for every format there are multiple permutations for ordering the terms. Couple that with the possibility that personal names, subdivisions, and even cities and counties may have common words and the barrier to creating processes for efficiently populating a searchable database from property records becomes clear.

Yet another barrier to creating an electronic searching system is the vast variety of documents used in different jurisdictions. Different states have different legal requirements and different customers, leading to different deeds, mortgages and the like. Further, even within a common jurisdiction, different title companies and different lenders use different documents. This reality makes it difficult to efficiently extract data from so many potentially different documents.

Thus, a need exists for improved systems and methods for searching property records and creating and maintaining databases related thereto.

### BRIEF SUMMARY OF THE INVENTION

Embodiments of the invention provide a method of populating a database. The method includes receiving a plurality of document images, defining a plurality of standard document types, mapping each of the plurality of document images to one of the plurality of standard document types and processing each document image through a data extraction process. S specific document image's path through the data extraction process is based, at least in part, on the mapping and the data extraction process posts data from each document to the database. The method also includes receiving a request from a user for data contained in the database, selecting the data using the request, and displaying the selected data to the user.

In some embodiments, the document images may relate to recorded documents relating to property transfers. Defining a plurality of standard document types may include identifying data fields to be captured during the data extraction process, determining how data extracted from a document image relating to the document type will be selected during the selecting step, and determining how the data extracted from a document relating to the document type will be displayed during the displaying step. Mapping each of the plurality of document images to one of the plurality of standard document types may include receiving an index of recorded documents relating to the plurality of document images, using the index and the standard document types to create a mapping table, and using the mapping table to assign a temporary standard document type to the document images. The method may include using optical character recognition performed on one or more document images to confirm the temporary standard document type assignment. The method also may include using pattern recognition performed on one or more document images to confirm the temporary standard document type assignment. The method also may include using a combination of optical character recognition and pattern recognition performed on one or more document images to confirm the temporary standard document type assignment.

In other embodiments, a system for populating a database includes a computing system having a processor and memory and instructions maintained on the memory. The instructions include instructions executable by the processor to receive a plurality of document images, map each of the plurality of document images to one of a plurality of standard document types, and process each document image through a data extraction process. A specific document image's path through the data extraction process is based, at least in part, on the mapping. The data extraction process posts data from each document to the database. The instructions also include instructions executable by the processor to, in response to a request for data from the database, select the requested data and send it to a user.

Still other embodiments provide a computer-readable medium having maintained thereon computer-executable instructions to program a computer. The instructions include instructions that program the computer to receive a plurality of document images, map each of the plurality of document images to one of a plurality of standard document types, and process each document image through a data extraction process. A specific document image's path through the data extraction process is based, at least in part, on the mapping. The data extraction process posts data from each document to the database. The instructions also include instructions that program the computer to, in response to a request for data from the database, select the requested data and send it to a user.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a title searching system according to embodiments of the system.

FIG. 2 illustrates a title searching method according to embodiments of the invention.

FIGS. 3A and 3B illustrate exemplary source property record documents.

FIG. 4A-4D illustrate methods of converting property records to data according to embodiments of the invention.

FIGS. 5A-5F illustrate exemplary output documents according to embodiments of the invention.

FIGS. 6A-6F illustrate exemplary display screens for interacting with the system according to embodiments of the invention.

### DETAILED DESCRIPTION OF THE INVENTION

Embodiments of the present invention provide systems and methods for automating the process of property records searching. In some embodiments, the present invention produces a data summary in response to a query that identifies a parcel, a grantor, and/or a specific document associated with the parcel. In some embodiments, the data summary is a title abstract. A title abstract according to some embodiments has sufficient information to allow a title policy underwriter (title examiner, examiner, underwriter, or abstracter) to provide a title commitment using commonly-accepted title policy underwriting rules. Thus, the systems and methods disclosed herein can produce or be used to produce a title commitment and/or title policy without reference to the source property record documents. In some embodiments, the data summary has sufficient information to assess the quality of the title of a parcel that is being used to secure a loan, using commonly-accepted loan underwriting rules, without reference to the source property record documents.

While embodiments of the invention disclosed herein are described in relation to searching property records associated with real property, this is not a requirement. The systems and methods described herein may be applied to records searches relating to personal property, professional licenses, corporate filings, and the like. Those skilled in the art will recognize many other examples in light of the disclosure herein. Further, while the specific examples used herein refer to title policies, title abstracts, title commitments, and other title and real estate industry-related product outputs, these examples are not intended to limit the scope of the invention. As previously mentioned, embodiments of the invention may be used by loan underwriters to assess the quality of the collateral (i.e., title for the parcel) and approve a loan, using commonly-accepted loan underwriting rules, without reference to the source property record documents. Embodiments of the invention may produce or be used to produce other types of output, including standard templates or forms and derivates of these templates or forms: American Land Title Association (ALTA) Loan Policy; ALTA Owner's Policy; ALTA Short Form Residential Loan Policy; Homeowner's Policy of Title Insurance for a One-to-Four Family Residence; Standard Exceptions to the ALTA Loan Policy; endorsements to ALTA policies; a Title Information Report (TIR) or “Prelim”; a title commitment for policies such as the foregoing; a Full Abstract—Refinance; a Full Abstract—Purchase; an “O&E”; and the like.

In some embodiments, the searching process is enabled by the collection of a comprehensive set of property record data covering a specified period of time for a given geographic area. The data set is then stored in a searchable database. For example, in a specific embodiment, data from all property records in a particular county for the past ten years is reduced to electronic form. In another embodiment, the period includes all records going back to the time of the original land grant. In other embodiments, the time period may be longer or shorter than these examples and may be determined based on local practice, underwriting requirements, the statute of limitations relating to correcting defective property transfers in the subject region, or the like. Other examples exist.

While the geographic region typically is a county, other larger or smaller regions may be used. For example, some embodiments may operate only on a subdivision or planned urban development (PUD), while others operate on an entire state or region of the country. The region typically is determined to be the region covered by the recording entity.

The records may come from a county courthouse, state courthouse, federal court records, bankruptcy records, tax and assessor records, Geographic Information System (GIS) records, and the like. The records from which the data set is collected may include deeds, mortgages, UCC filings, liens, releases of liens, releases of mortgages, judgments, lis pendens, federal tax liens, state tax liens, maps, plats, and the like. The items of data collected include: property address, legal description, grantor name, grantee name, document date, recordation data, reception number, document type, other items to be identified hereinafter, and the like.

Embodiments of the present invention do not merely collect electronic images of recorded documents. Further, embodiments of the invention do not merely digitize data (e.g., grantor, property address, legal description, and the like) to create electronic indexes used to locate source documents. Embodiments of this invention reduce a comprehensive set of property records to a form that may be entered into a searchable database and used to complete the searching process, not merely locate source documents that then must be examined. The systems and methods described herein produce output (e.g., a paper document, an image on a computer screen, an electronic data file) that contains sufficient information to underwrite any of many different types of title commitments or title policies, as referenced earlier herein, or the like, without reference to the source documents. Of course, the systems and methods described herein may be used for other purposes, such as, for example, legal disputes, real estate research and due diligence, constructing an offer to buy, fraud detection, loan portfolio risk management, easement identification, data mining, marketing, or merely to satisfy some curiosity relating to the ownership history of a parcel. Many other examples are possible.

The data to be included in the set may be determined by commonly-accepted rules for the particular task. These may include: local title policy underwriting rules, federal loan underwriting rules, state insurance rules, local loan underwriting rules, customer-specific rules, and the like. As an example, if commonly-accepted title policy underwriting rules base an underwriting decision on whether a particular parcel abuts a body of water, then the data set will include a field for waterfront property information. In some examples, this may be merely a binary field having one value for waterfront property and another for non-waterfront property. In other examples, however, additional fields may be included that indicate the type of body of water, the portion of a parcel that abuts the water, and the like. Many other such examples are possible.

The process for converting property record documents or document images is complex. Embodiments of the invention provide various methods and systems for accomplishing this. Some embodiments of the invention relate to systems and methods for efficiently mapping various documents to a standard document set. Any given county or recording entity records many different document types (mortgages, deeds, releases, liens, etc.) and multiple versions of each document type. Some embodiments of the present invention classify recording entity documents into a finite set of document types. These document types map to a pre-determined set of document types that are pre-configured for data extraction. Pre-configuring each document type may entail, for example, identifying the data elements to obtain from the document, identifying the locations of the data elements on the document, identifying related documents, and/or the like.

Once documents are classified, each document image is segmented into data regions. Data regions contain blocks of text (e.g., legal descriptions, ownership interests, tenancies of ownership, terms and conditions, and/or the like) from which specific data elements are pulled. Images of data regions are converted to text through manual processes, optical character recognition, or other processes.

In some embodiments, the classified documents may be processed through a number of different processing states. Merely by way of example, a first processing state may be applied to extract data elements (e.g., grantee, grantor, legal description, marital status, tenancy, etc.) from text fields associated with the document. Subsequent processing states may further process the extracted data elements to obtain attributes associated with the data elements. For instance, data elements that may include names (e.g., grantee, grantor) may be further processed to extract last name and/or first name attributes. As another example, a legal description data element may further be processed to extract attributes, such as subdivision name, lot number, etc. Other types of processing states are also contemplated.

While processing documents through a document processing state, one or more errors may be encountered which may require operator intervention (e.g., the process may not be able to extract a name from a grantee text field). These documents may be placed in an exception state until operator input is received. Once the operator input has been received resolving the error, the document may return to the same processing state at which the error was encountered or may be advanced to the next processing state.

Embodiments may allow documents to exist in multiple states simultaneously. This may allow faster document processing, especially in the event an error results in one of the processing states. Optionally, different document states may be processed on different machines (perhaps concurrently).

Some embodiments of the present invention relate to systems and methods for parsing the text blocks into data elements. Any given text block may contain, for example, one or more names, one or more property addresses and/or legal descriptions, tenancy clauses, and/or the like. Some embodiments first use context to separate the various data elements into constructs, which may be single words (i.e., “tokens”) or longer phrases of related elements (e.g., a full name). Some embodiments also or alternatively use confidence to separate data elements. Still other embodiments use a combination of the two.

With respect to embodiments that use context to parse text blocks, a parsing engine is initialized with rules and data relevant to the string being parsed. For instance, if a legal description is being parsed, a subdivision table may be used to initialize the parsing engine so that the parsing engine knows when it encounters a subdivision name. A rule may state that a lot and block number should be present in a text block having a subdivision name, in which case the parse engine will include the subdivision name, the lot number, and the block number in a single construct. In another example, phrases such as “husband and wife” in a tenancy clause should be preceded by a pair of personal names and a rule should state such. The parse engine then may include the names and the tenancy clause in a single token. Many other examples exist.

With respect to embodiments that use confidence to parse text blocks, a parsing engine is initialized with confidence-based rules relevant to the string being parsed. For example, a censes database may be used to assist with distinguishing between first and last names. For example, some names (e.g., “Smith”) are commonly last names, some names (e.g., “Jonathan”) are commonly first names, and some names (e.g., “Charles”) may be either a first name or a last name with nearly identical frequency. Appropriate confidence-based rules use statistics from a census database or the like to parse a name construct by evaluating the frequency with which each name in the construct is a first name and/or last name and assigning the names to data fields accordingly. Other rules may evaluate punctuation, word ordering within a construct, and the like to assign words in a construct to data elements. Other examples exist.

In some embodiments, data is document-centric, although other examples are possible (e.g., person-centric; parcel-centric). In document-centric embodiments, even though the information is stored in searchable form, for example in a relational database, the data is organized, at least initially, according to documents. The documents correspond to specific recorded property records having potentially-relevant property data. Thus, in these embodiments, the automated searching process resembles the process a searcher might perform manually: the process identifies documents having data related to a property and evaluates the data to determine if the document is relevant to issuing a policy on the property. Irrelevant documents are ignored, and the data on relevant documents are summarized in an abstract from which an underwriter may generate a commitment.

In some embodiments, the abstract (or other output) may include a list of documents and a relevance score for each document. The score may be generated using any of a number of scoring algorithms. For example, the score may be based on a number of comparisons between the document being scored and a source document or group of documents. The more closely the data on the document match that on other documents or the data used to initiate the search, the higher the score and vice versa. The score may be based, at least in part, on the number of ways a document is located (e.g., name search, grantor search, address search, legal description search, and the like). The more searches that return a document, the more likely the document is to be relevant and the higher the score. The score may be weighted to favor data elements of greater significance. Many such examples are possible.

In some embodiments, the output may include a score, a grade, or a list of exceptions that summarizes the data gathering process in a meaningful way in a manner similar to the way credit reporting agencies score credit reports. The score could be based on specific customer requirements or could be industry standard scores.

As mentioned previously, the output may assume any of a number of forms. The output may be electronic or paper, for example. Paper output may be an abstract, portions of an abstract, a policy, a chain of title, a commitment, a document list, and the like. In addition to these, electronic output may include hyperlinks that allow a user to obtain more detailed information about an item or navigate among different portions of the output. For example, although not needed to underwrite a policy, an underwriter may desire to view an image of a relevant document. A hyperlink in a listing of documents may be used to return the image. Many other examples are possible.

In some embodiments, the output includes an electronic file having data that may be used for any of a number of purposes. The file, which may be transmitted as a data stream over a network between computing devices, may be an ASCII text file, a comma-delimited file, or the like. The file may be in EDI, EDIFACT, ANSI X12, or other suitable format. The file may include XML elements or tags, XML attributes, DTDs, LDDs XML schemas, and the like. Many other examples are possible and apparent to those skilled in the art in light of this disclosure. The information transmitted in the electronic file may be used, for example, to populate fields in documents such as policies, mortgages, deeds, and the like.

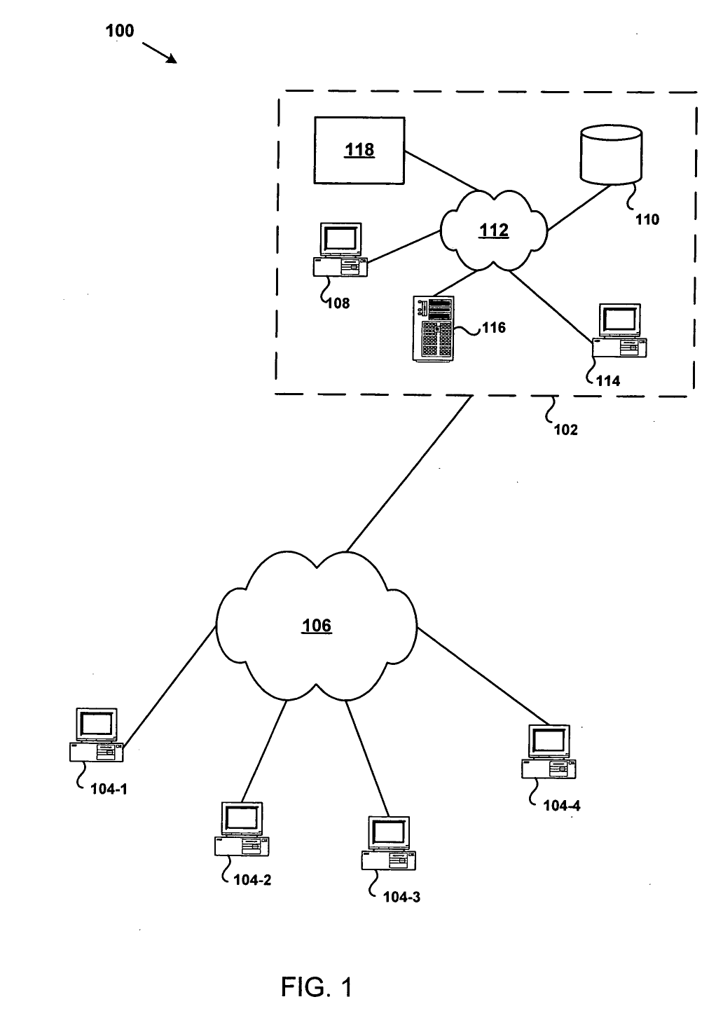

Having described embodiments of the invention generally, attention is directed to FIG. 1, which illustrates an example of a property records searching system 100 according to more specific embodiments of the invention. The system 100 includes a host computer system 102. The host computer system 102 may include any of a number of computing devices, peripheral devices, network devices, input devices, output devices, and the like. All the devices that comprise the host computer system 102 may be co-located at a single facility or distributed geographically. In a specific embodiment, the host computer system 102 is a single computing device that users 104 may access via a network 106. Many other examples are possible.

In a specific embodiment, the host computer system 102 includes a workstation 108, a data storage arrangement 110, and an internal network 112 that allow the two to communicate. The workstation 108 may be any computing device or combination of computing devices capable of performing the processes described herein. The workstation 108 includes a processor and software that programs the processor to operate according to the teachings herein. The storage arrangement 110 may be, for example, any magnetic, electronic, or optical storage system, or any combination of these. The storage arrangement may be a server, or combination of servers having RAM, ROM, hard disk drives, optical drives, magnetic tape systems, and the like or any combination. In some embodiments, each geographic region is represented by a server or group of servers. Many other examples are possible. The internal network 112 may be any of a number of well-known wired or wireless networks or combinations thereof. For example, the internal network may be a LAN, WAN, intranet, the Internet, or the like. Many other examples are possible. The host computer system also may include administrative computers 114 (e.g., personal computers, laptop computers, and the like) that may be used to assist in the operation of the system. The host computer system 102 also may include network interfaces 116 (e.g., web server) that enable communication between the host computer system 102 and users 104.

The host computer system 102 also may include an input system 118. In its most basic form, the input system 118 receives source property records, converts the property records to searchable data, and delivers the data to the storage arrangement. This process will be described in greater detail hereinafter. The input system 118 need not be a single device, nor located at a single location.

The network 106 may be any wired or wireless network, or any combination thereof. In a specific embodiment, the network 106 is the Internet. The users 104 may be any computing device capable of providing a user access to the host computer system 102. In a specific embodiment, the user 104-1 is an underwriter's or abstracter's desktop computer through which he accesses the host computer system, via the Internet, for purposes of performing a search and underwriting a policy or loan for a customer.

Those skilled in the art will appreciate that the foregoing is but one example of a system according to embodiments of the invention. Many other examples are possible.

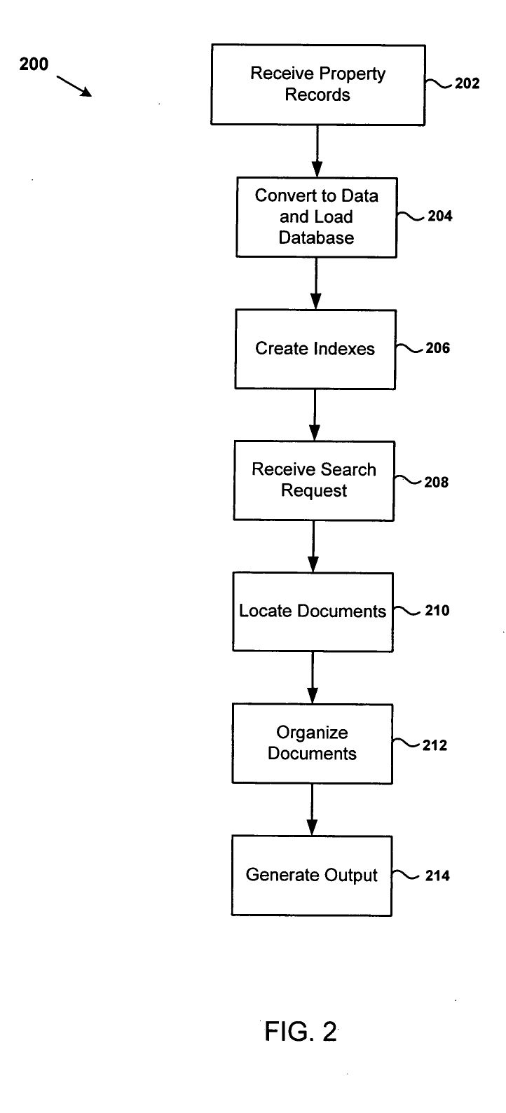

Having described an exemplary system according to embodiments of the invention, attention is directed to FIG. 2, which illustrates an exemplary method 200 according to embodiments of the invention. The method may be implemented in the system 100 described above or in another suitable system. Those skilled in the art will appreciate that alternative methods according to embodiments of the invention may include more, fewer, or different steps than those illustrated and described herein. Further, the steps may be performed in different orders than described herein with respect to this exemplary embodiment.

The method 200 begins with the receipt of property records at block 202. The records may be received in any of a number of forms. For example, in some embodiments, the property records are received as paper copies of all documents recorded in a given jurisdiction. In other embodiments, the property records are received as a collection of image files. The image files may be stored in magnetic (e.g., on one or more computer disks) or optical (e.g., on one or more CDs) form, or the like, or a combination of such. The image files may include microfilm or microfiche images. Many other examples are possible.

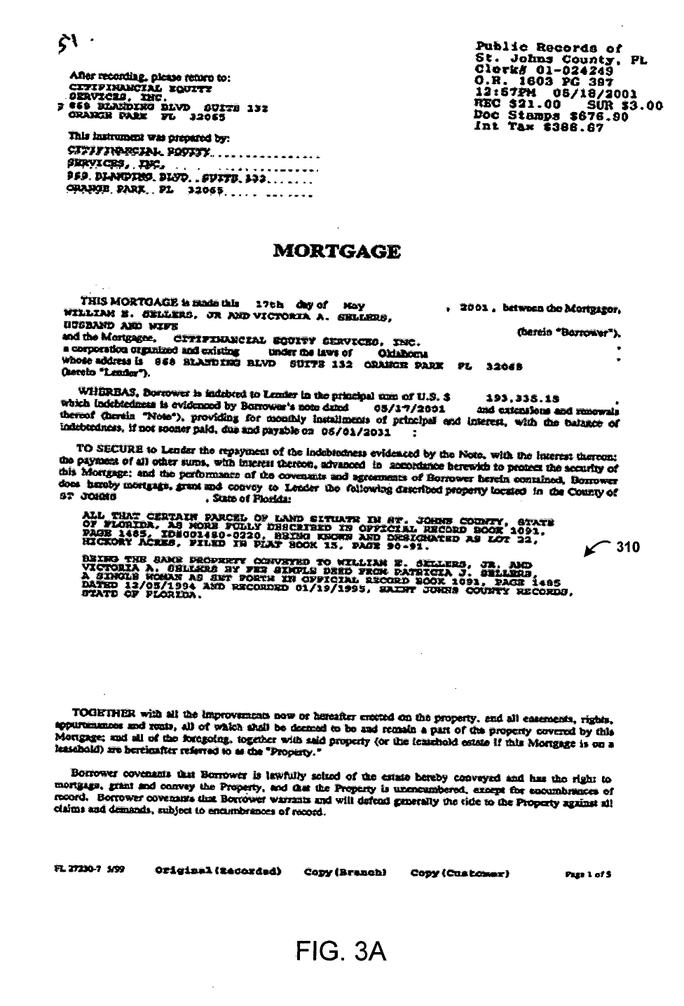

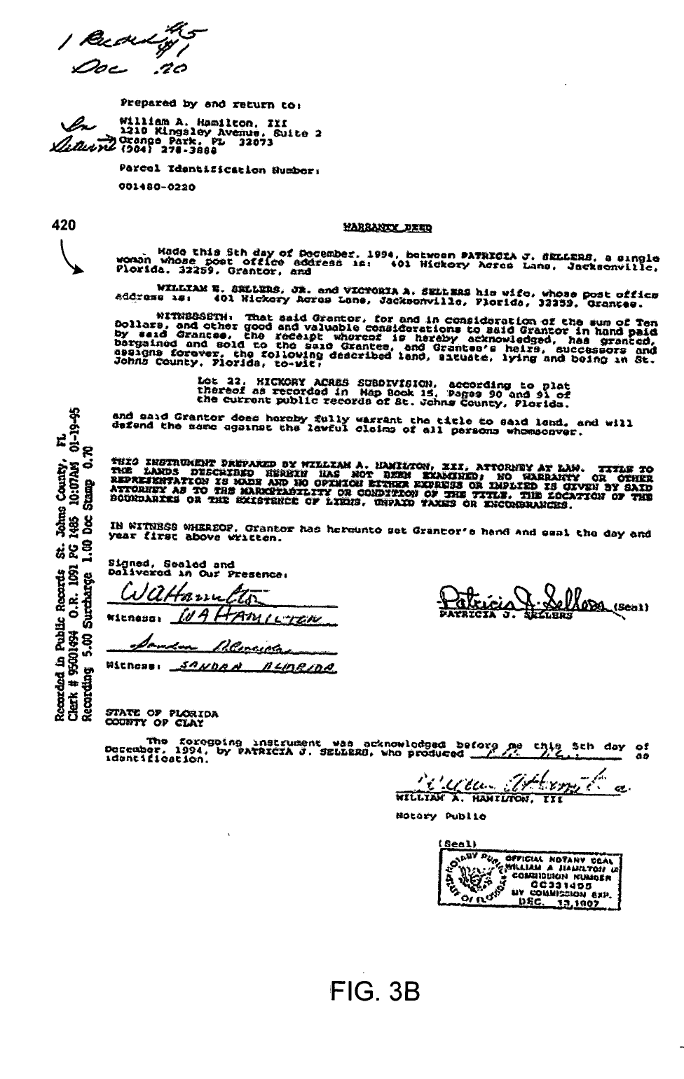

As mentioned previously, the property records may include deeds, mortgages, liens, releases, and the like. FIGS. 3A and 3B illustrate examples of the types of property records that serve as source documents according to embodiments of the invention and the data that are gathered there from. For example, FIG. 3A illustrates a mortgage. The mortgage includes a mortgagor name, a mortgagee name, a transaction date, a legal description, a recordation date, and the like. FIG. 3B illustrates a warranty deed. The deed includes grantor, grantee, legal description, and the like. Those skilled in the art will appreciate many other examples of recorded documents and the data contained thereon.

At block 204, the property records are converted to data and loaded into a database such as the storage arrangement 110 of FIG. 1. This may involve use of the input system 118 of FIG. 1. This process is described in greater detail hereinafter and in previously incorporated provisional U.S. Patent Application No. 60/554,511, (Attorney Docket No. 040143-000100). Briefly, however, this comprises extracting from the property records all data needed to underwrite a policy, loan or the like according to commonly-accepted underwriting rules. A specific embodiment includes extracting the following field codes, some of which are followed by comments: RECEPTION_NUM=0; BOOK=1; PAGE=2; RECORD_DATE=3; DOCUMENT_DATE=4; DOLLAR_AMOUNT=5; INT_RATE=6; PREVIOUS_DOCUMENT_DATE=7; SOCIAL_SECURITY=8; // new, for liens MATURITY_DATE=9; // new, for liens CASE=10; JURISDICTION=11; PREVIOUS_RECEPTION_NUM=12; PREVIOUS_BOOK=13; PREVIOUS_PAGE=14; DOC_FEE=15; LEGAL_DESCRIPTION=16; DOC_TITLE=17; GRANTEE=18; GRANTOR=19; THIRDPARTY=20; MISC_INDEX_DATA=21; FOURTHPARTY=22; CREDITLIMIT=23; // credit limit text STREETADDRESS=24; // amount, if found and CREDITLIMIT=yes SIGNATURE=25; // signature found on doc RERECORDED=26; // rerecording information found on doc PREVIOUSDOCKETNUMBER=27; DECLARATIONSRECORDINGDATE=28; // with label COLLATERALLISTED=29; CONDOYESNO=30; RERECORDEDRECORDINGDATE=31; RERECORDEDRECORDINGREASON=32; POAREASON=33; TERMINATIONDATE=34; // with label SALEDATE=35; VOLUME=36; TYPEOFPROPERTY=37; APPURTENANCES=38; STARTDATE=39; // with label PERCENTOWNERSHIP=40; LARGEVSSMALLPUDFLAG=41; DOCKETNUMBER=42; REDEMPTIONMADEBY=43; SALEIDNUMBER=44; CAPTUREDTAXIDNUMBER=45; PUDYESNO=46; HELDASLEASEHOLDYESNO=47; HELDASFEESIMPLEYESNO=48; DEFENDANTDEBTOROBLIGEESSN=49; DEFENDANTDEBTOROBLIGEEFEIN=50; PLAINTIFFCREDITORCLAIMANTSSN=51; PLAINTIFFCREDITORCLAIMANTFEIN=52; CORRECTEDAMENDEDREASON=53; UCCRECNUMBER=54; PARCELIDNUMBER=55; CONCLUSIONS=56; PURPOSEOFEASEMENT=57; AFFECTEDPROPERTY=58; PREVDOTAMOUNT=59; NEWDOTAMOUNT=60; TENANCY=61; CORRECTEDAMENDEDBOOLEAN=62; CORRECTEDAMENDEDRECORDINGDATE=63; CORRECTEDAMENDEDPREVIOUSRECEPTIONNUMBER=64; MERSNUMBER=65; CERTIFIED=66; // Is the court decree certified. Typically is yes/no boolean. SURCHARGEFEE=67; // Surcharge noted on document. INTANGIBLETAX=68; NOTARY=69; TORRENSTITLENUMBER=70; WITNESSES=71; HOMESTEAD=72; PREV_BOOK_PAGE=73; // may replace the two separate PREV_BOOK & PREV_PAGE fields. Those skilled in the art will recognize many other examples in light of the disclosure herein.

Once extracted, data are loaded into a database, for example a searchable relational database, and stored for future use. Data may be stored such that all data from a specific record, parcel, person, or the like, is logically grouped together. This preserves the data as a document, yet allows the data to be searched in many different ways.

At block 206, indexes are created that enhance the efficiency of future searches. Creating indexes may include creating a unique pointer for individual parcels and using the pointers to identify any document (i.e., data group) relating to the parcel. Other indexes may be created for grantors, grantees, and the like. Those skilled in the art will recognize other possibilities for creating indexes in light of this disclosure.

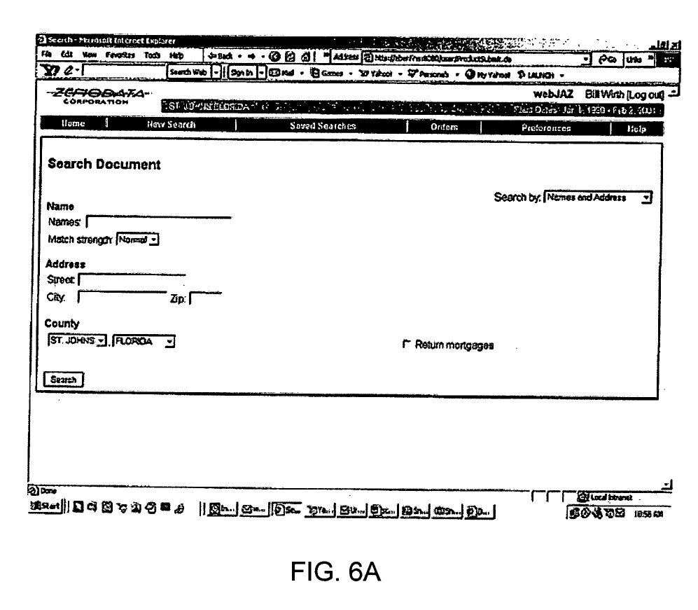

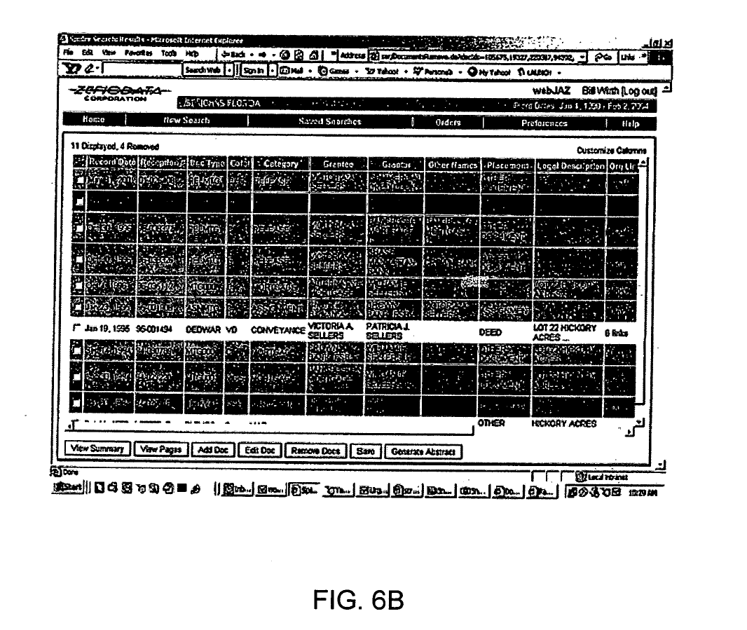

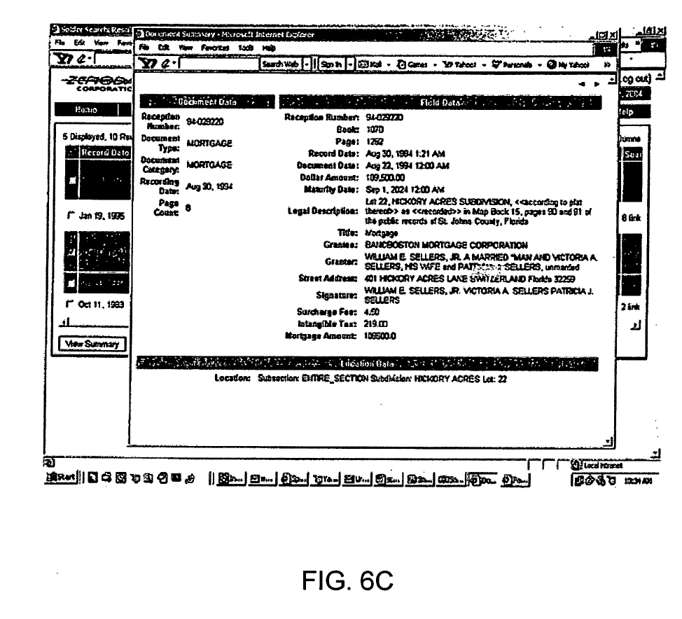

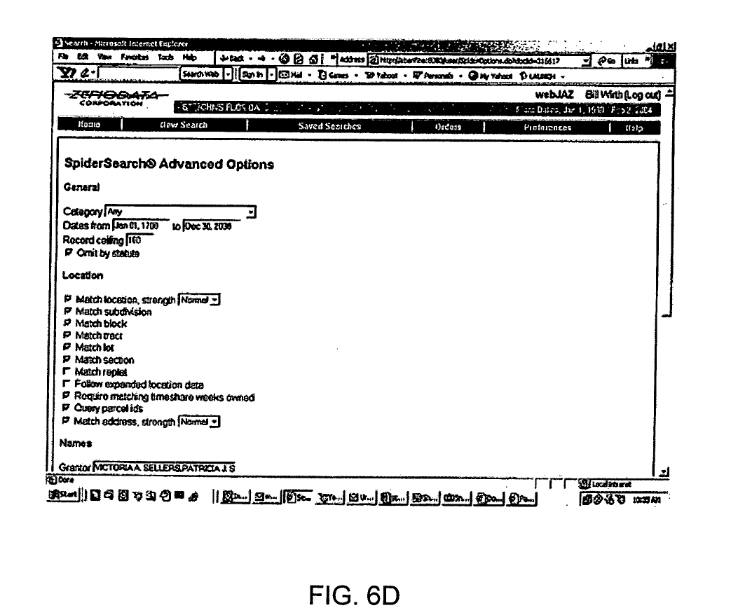

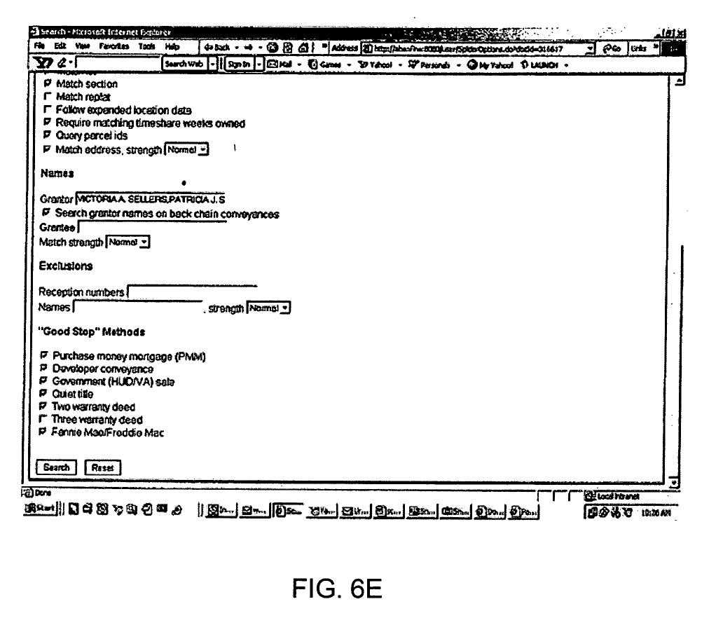

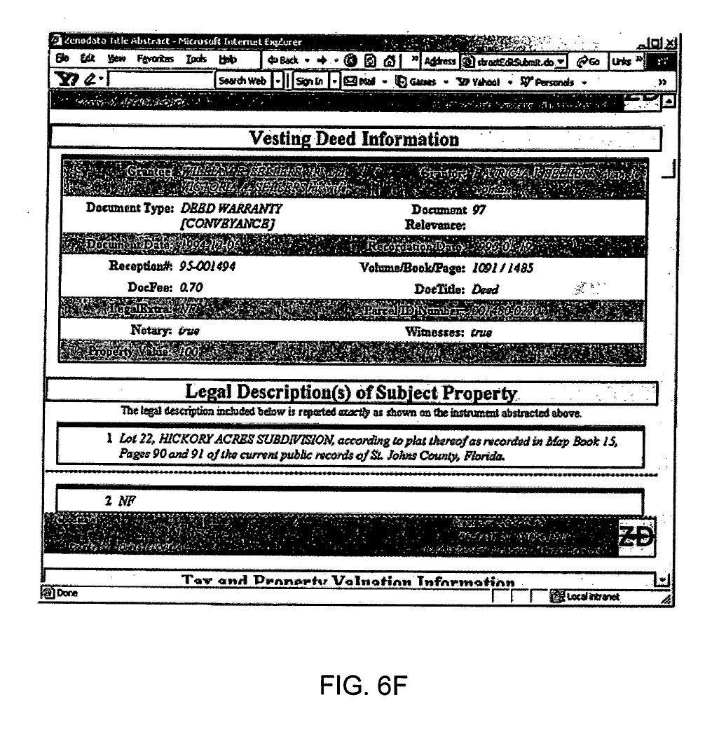

At block 208, a search request is received. In a specific embodiment, this comprises receiving a request via a network (e.g., the Internet, or other network represented by the network 106 of FIG. 1) from a user, such as one of the users 104 of FIG. 1. The request may comprise one or more data elements on which the user would like to base the search. Exemplary data elements include the property address, a legal description of the property, the grantor in a property transaction, and the like. In some embodiments, the user may supply a specific document (e.g., by providing the reception number of the recorded document) on which the user desires the search to be performed. The user may use display screens such as those described hereinafter with respect to FIGS. 6A-6F. The request also may include a request for specific output. For example, the user may want a document list, an abstract, a policy, a title marketability score or grade, and/or the like.

At block 210, potentially relevant documents are located. This process is described more fully in previously-incorporated U.S. patent application Ser. No. 10/804,468, entitled “DOCUMENT SEARCH METHODS AND SYSTEMS” (Attorney Docket No. 040143-000300). Briefly, however, this comprises using the stored data to identify documents potentially related to the data elements in the user's request. Whether a document is relevant may be based on the type of search the user requested. The search may use one or more indexes created at block 206 to improve the efficiency of the search. With respect to some embodiments, searches may locate potentially relevant documents in multiple ways, for example, using the grantor, the legal description, the address, and/or the like. As documents are located, additional searches may be performed using data from these documents. Thus, a document may be identified as potentially relevant based on more than one data element. This helps to lessen the possibility that a relevant document will not be located due to typographical errors or other mistakes present on the recorded document.

Once located, potentially-relevant documents are organized at block 212. Organizing documents is more fully described in previously-incorporated U.S. patent application Ser. No. 10/804,467, entitled “DOCUMENT ORGANIZATION AND FORMATTING FOR DISPLAY” (Attorney Docket No. 040143-000400). Briefly, however, this involves any of a number of processes that correlate documents in a manner previously accomplished manually. For example, this may involve matching mortgages with mortgage releases, matching liens with lien releases, constructing a chain of title, locating a good stop for a chain of title, matching multiple grantees in a transfer to grantors in a subsequent transfer, and the like.

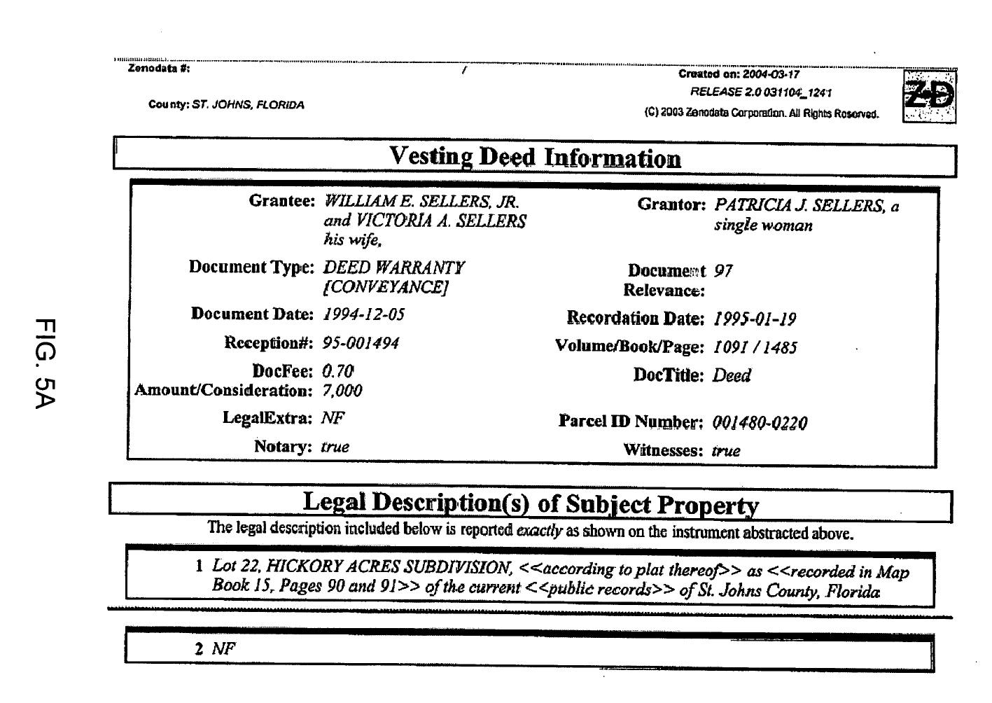

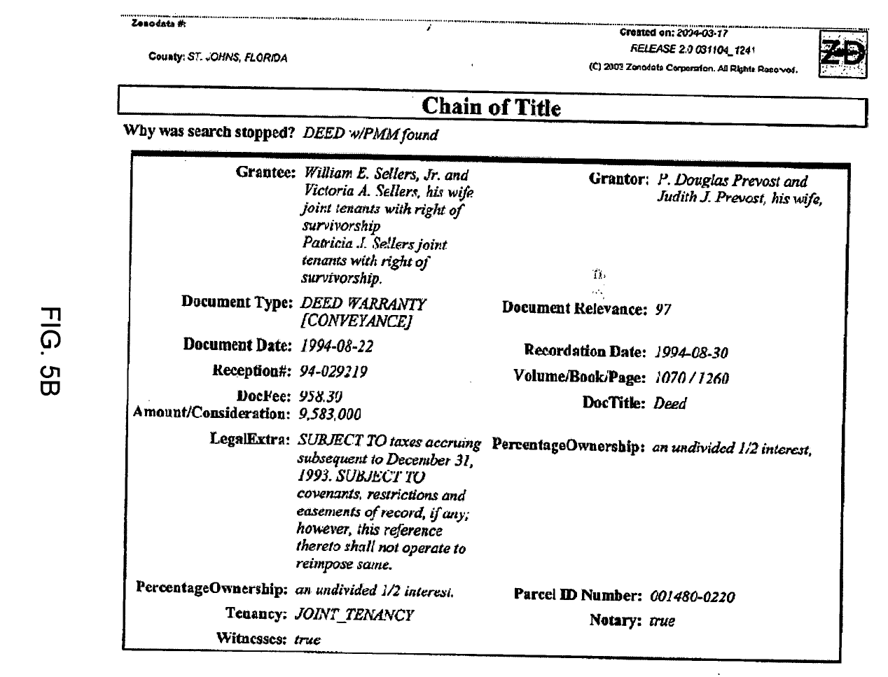

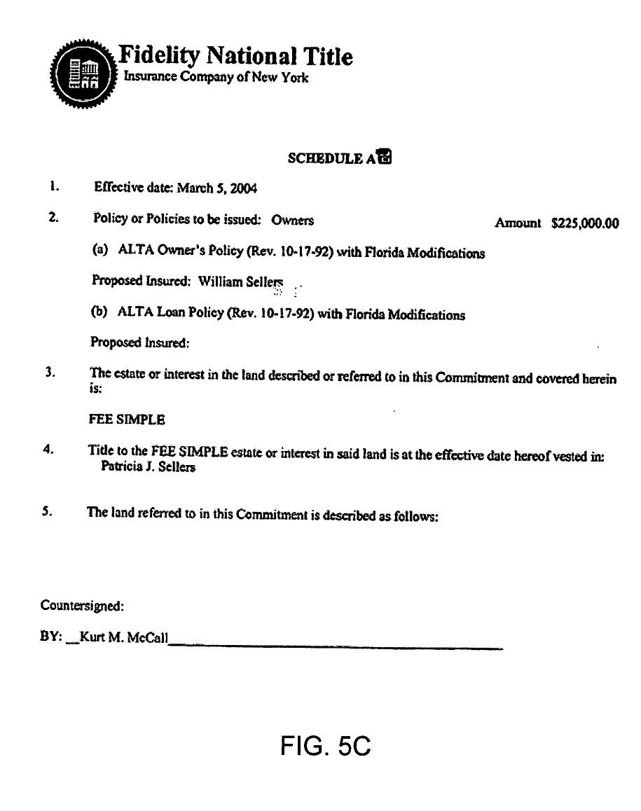

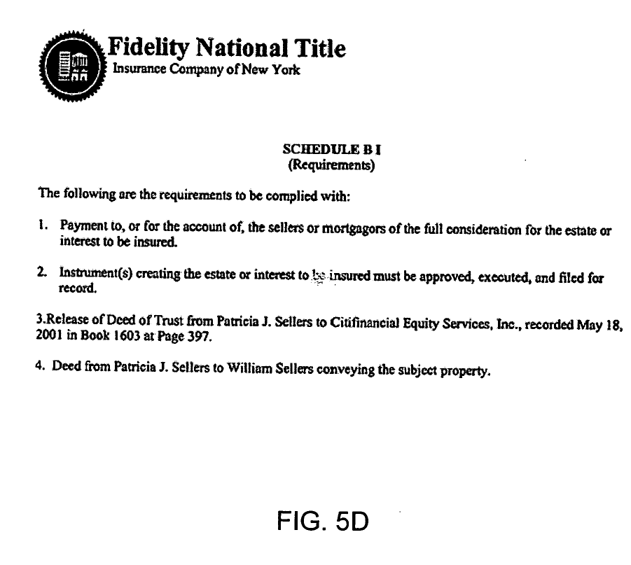

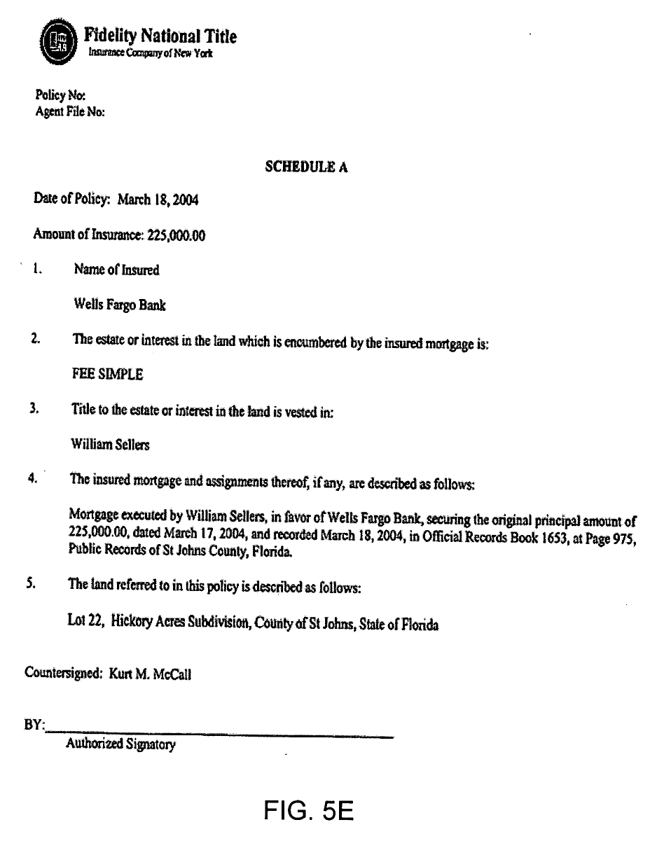

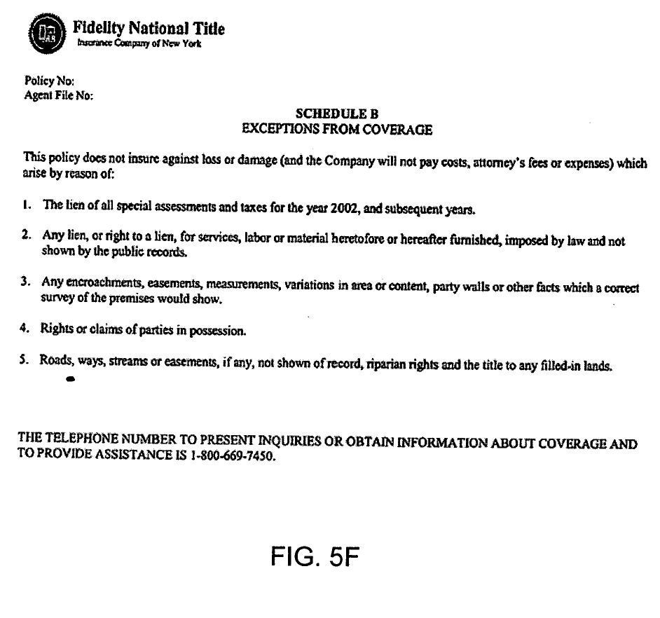

At block 214, output is produced. The output may comprise any or all of the items identified in the user's request. The output may be an electronic file sent to the user, a display screen on the user's computer, a fax to the user, a printout mailed to the user, and the like. If the output is electronic, it may include hyperlinks to more detailed information, to document images, and the like. Exemplary output documents are described hereinafter with respect to FIGS. 5A-5F.

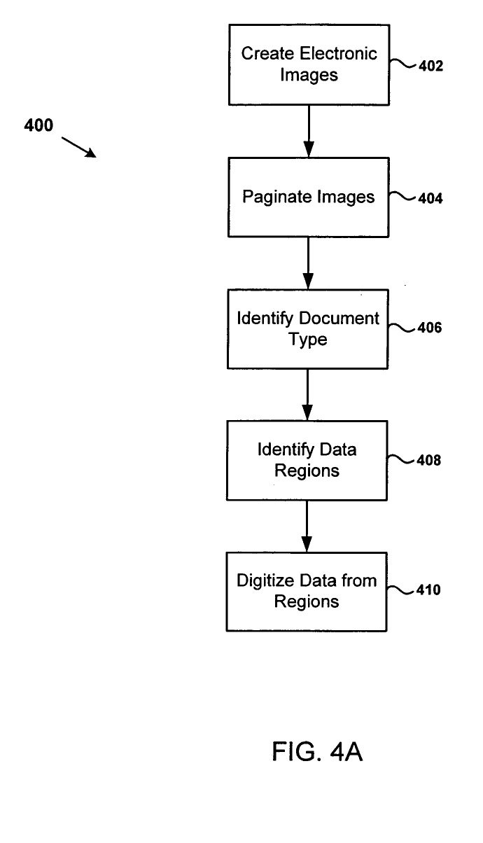

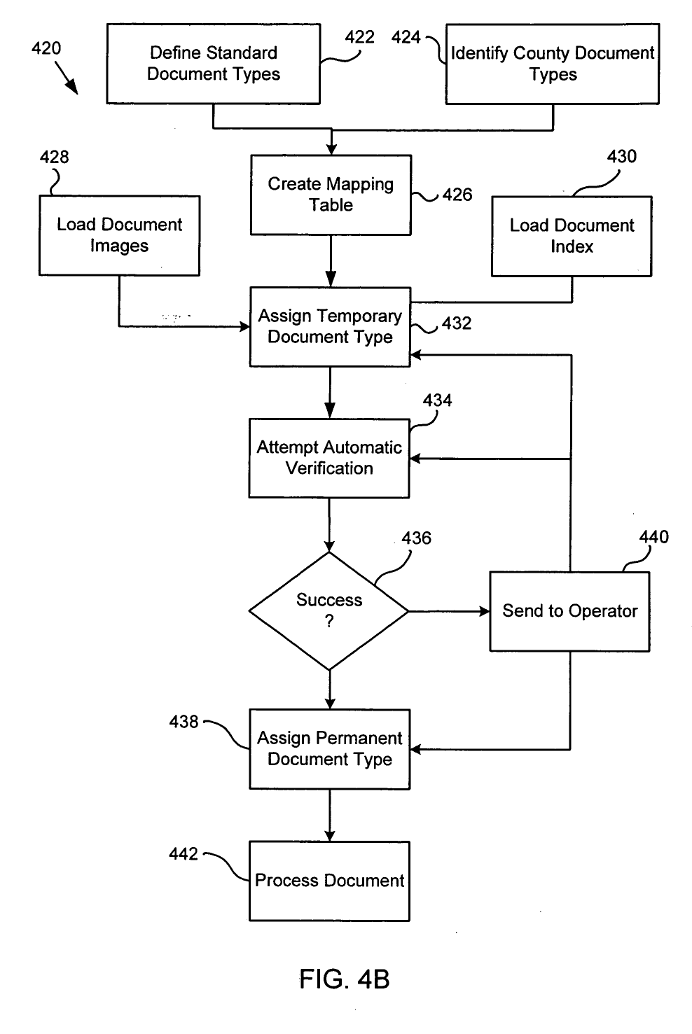

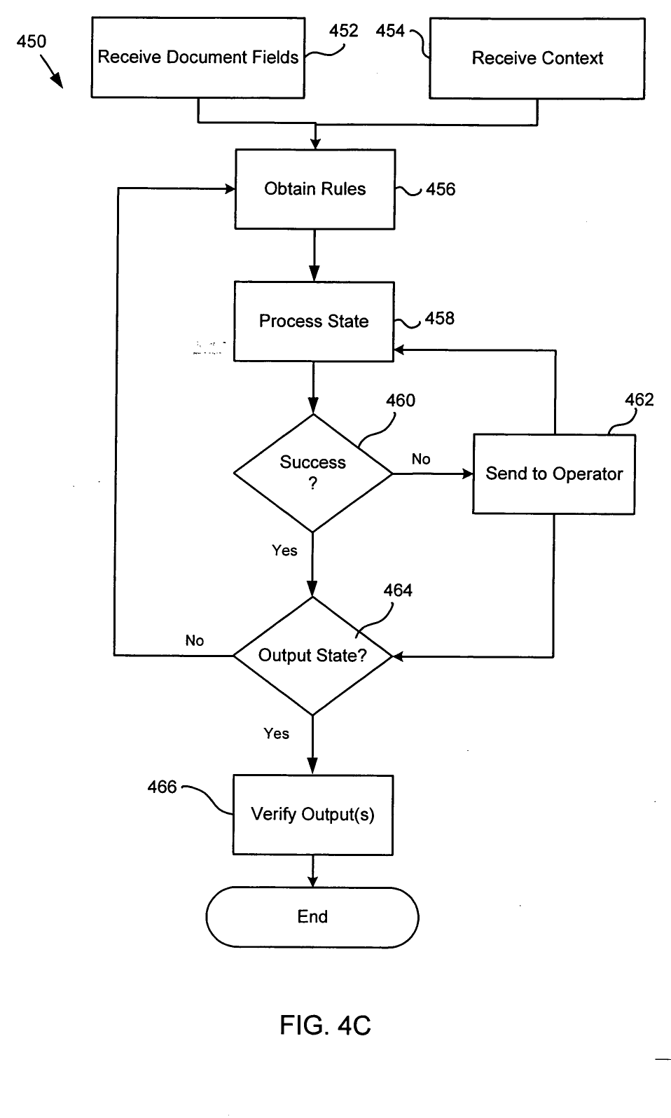

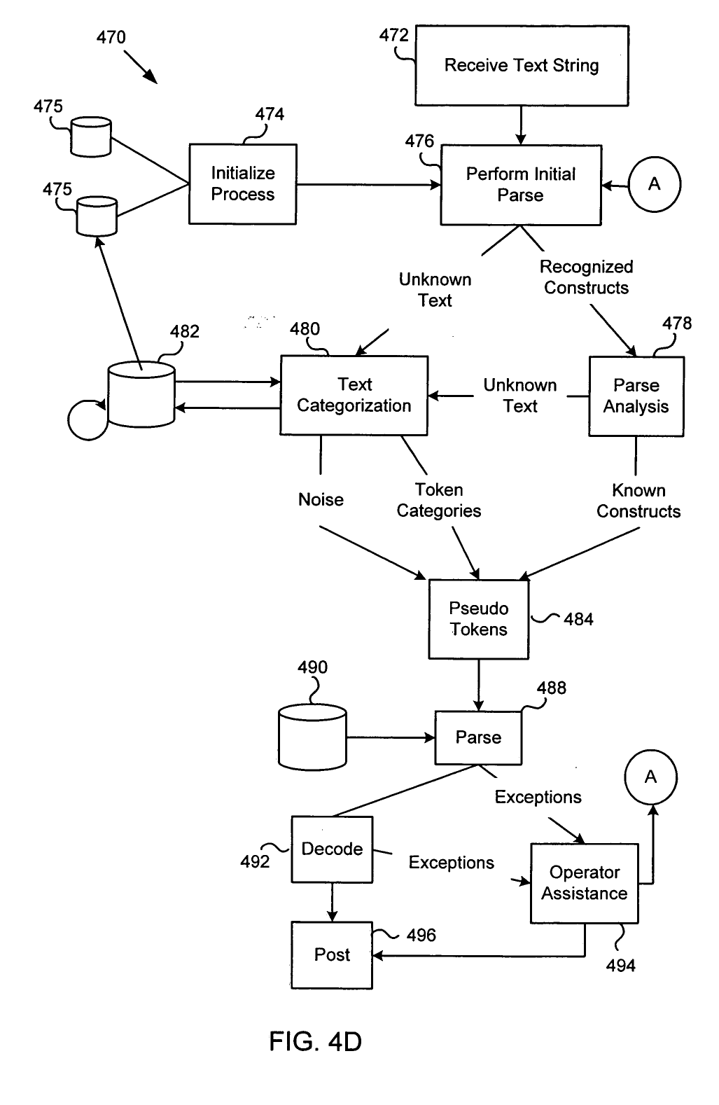

Attention is directed to FIG. 4A, which illustrates an exemplary data input method 400 according to embodiments of the invention. The method 400 may be implemented in the data input system 118 of FIG. 1 or other appropriate system. This process is described in greater detail in previously incorporated Provisional U.S. Patent Application No. 60/554,511, (Attorney Docket No. 040143-000100). At block 402 electronic images are created of recorded property records. In some embodiments, this is done by the recording entity; in others, this is done by other entities. The process may involve scanning from paper, microfilm, microfiche, and/or the like.

The process continues at block 404 wherein the electronic images are logically paginated and grouped. Many recorded documents extend over several pages and identifying breaks between documents may be necessary. This process may be accomplished manually or electronically. If accomplished electronically, the input system 118 may be programmed to recognize various indications of a document break. When such a break is encountered, the system inserts an indicator that signals the break for future operations.

At block 406, each group of pages representing a common document is evaluated to identify the document's type. This also may be done electronically or manually. If done electronically, the input system 118 may be programmed to identify document titles or other indicators of a document's type. The input system 118 also may be programmed to evaluate the content of a document, using, for example, optical character recognition (OCR), to determine the document type based on the content. Other examples are possible.

At block 408, data regions are identified on the document. This process may be assisted by having previously identified the document type. Certain types of documents have consistent data regions. Often the regions are located at a consistent location on the document. Thus, in some embodiments the process may be automated and may use OCR to evaluate the content of the region to confirm proper identification. Although OCR may be used, it is not necessary at this stage to parse the content. It is sufficient to merely confirm that the content “looks like a legal description,” for example.

Once the data regions are identified, the content of the regions is digitized at block 410. Digitizing the content involves converting the image information to searchable data that may be loaded into a database. In some embodiments, this involves using OCR and translation algorithms to parse the information, evaluate its content, segment it into appropriate data elements, or post documents to a particular geographic location in the database to aid in searching and locating. Translation algorithms may be specifically designed to work with the types of records being operated on. Exemplary translation algorithms are more fully described in previously-incorporated Provisional U.S. Patent Application No. 60/554,514, entitled “CONFIDENCE-BASED NATURAL LANGUAGE PARSING” (Attorney Docket No. 040143-000500), Provisional U.S. Patent Application No. 60/554,513, entitled “CONTEXTUAL CONVERSION OF LANGUAGE TO DATA” (Attorney Docket No. 040143-000600), and herein. In some embodiments, the digitizing process is performed manually. For example, data entry clerks may view the content of a data region and manually enter the content into an input device. The process may be highly automated. For example, the input system may be programmed to extract data regions from many documents and present them one-at-a-time to a clerk who reads the information and keys it into an input device. Many other examples are possible, including those that use a combination of electronic and manual data entry.

Having described the data input method generally, attention is directed to FIG. 4B, which illustrates a more detailed process 420 for improving the efficiency of data extraction. Across the country and from county to county, documents or other instruments used for similar legal functions (e.g., property transfers) may look and read differently, their titles may differ, and their legal meaning may vary. It would be highly inefficient to design a unique process for extracting data from each unique document. Conversely, a “one-size-fits-all” document template for data extraction likely would produce so many errors that the process would be useless. One way to improve the efficiency is to define a number of “standard” document types, then map recorded documents to the standard document types as described herein.

The process 420 will be discussed in the context of a specific county, although the same process may be used in association with extracting data from any collection of documents whether associated with a single geographic region or group of geographic regions. In some embodiments, the process 420 includes steps from any of blocks 404, 406, and/or 408 in the method 400 of FIG. 4A.

The process 420 begins at block 422 at which point standard document types are defined. It would be inefficient to create a process for every conceivable document that might be encountered for a single county, let alone for every geographical region for which a searchable database might be created. Hence, a finite set of document types is created. In some embodiments, this may include creating a title, identifying data fields from which to extract data, identifying which of the data fields are complex data fields (having multiple data elements) and which are simple data fields (having only a single data element), identifying the general locations of the data fields on the document, listing the expected number of pages for the document, and/or the like. Some embodiments of the invention may simply create a title and identify data fields; other embodiments may define even more variables associated with each standard document type.

It should be understood that block 422 is accomplished only once in some embodiment. Thereafter, each time a new set of documents is to be processed, the same standard document types are used. Of course, new standard document types may be defined at any time.

At block 424, a listing is made of each document type in the set of documents to be processed. This may be accomplished in any of a number of ways. For example, an index of recorded documents for a county may be used to create a list. In some embodiments, document images are used to extract a title from each document and create a unique entry in the list each time a new title is encountered. Many other examples are possible.

At block 426, a document mapping table is created that maps each county document type to one of the standard document types.

At block 428, document images are received for processing. In some embodiments, the images are paginated (i.e., a beginning page and an ending page in each multi-page document have been identified as described previously at block 404 of FIG. 4A). In other embodiments pagination is accomplished as part of the document mapping process.

At block 430, an index is loaded, if available. The index may be, for example, the county's recording index (e.g., grantor/grantee index, recording index, etc.) that is associated with the document set from which data is to be extracted. The index may list a document title for each document in the set, along with, for example, the document's recording number. Many such examples are possible.

At block 432, the index and the mapping table are used to assign a temporary document type to each document in the set of documents. This may be accomplished by comparing the document title from the index to county document type entries in the document mapping table until a match is found. The corresponding standard document type then becomes the temporary document type for the corresponding document.

In some embodiments, a temporary document type is determined for each document image before the ensuing steps are performed. In other embodiments, the ensuing steps are performed for a first document before a temporary document type is selected for a subsequent document. In other embodiments, documents may be fully processed in small batches. In still other embodiments, documents are binned and processed accordingly. For example, if an exact match is made, the document is placed in a first bin, if no match is found, the document is placed in a second bin, and so on.

At block 434, an attempt is made to verify the document type. In some embodiments, this comprises using OCR to read a document's title from its image. The document title is then compared to the county document titles in the mapping table. If a match is found, the corresponding standard document type is compared to the temporary document type. In other embodiments, pattern recognition is applied to the document image to identify data fields and generally analyze the document's content. Still other embodiments use a combination of the foregoing.

At block 436, a decision is made, based on the analysis at block 434, whether the actual document type matches the temporary document type. If yes, the temporary document type is made permanent at block 438. Otherwise, the document is sent to an operator for further analysis.

At block 440, an operator analyzes the document in an attempt to make the temporary document type permanent. Operators may be specifically trained to recognize particular document types. Hence, the temporary document type may be used to route the document to a particular operator. The operator evaluates the document and performs one of several functions. The operator may assign a different county document type, if, for example, the index incorrectly listed the document's type. In this case, the document is routed back to block 432. The operator may assign a new temporary document type to the document and route the document to block 434. In some cases the operator may be able to select a permanent document type for the document, in which case the document is routed to block 442 for further processing.

Once a permanent document type is assigned, the document is processed through the data extraction process. The data extraction process may include, for example, the operations described previously at blocks 408 and 410 of FIG. 4A. In some embodiments, however, different document types are processed differently through the data extraction process. For example, a document that does not include a legal description does not need to be processed through a legal description parsing process.

Those skilled in the art will appreciate that other document mapping processes may include more, fewer, or different steps than those illustrated and described herein.

FIG. 4C illustrates an exemplary embodiment of a process that may be used to convert document fields into searchable data elements. The process 450 may be used as at least a portion of block 410 of FIG. 4A. Although the process 450 will be described with specific reference to recorded documents related to property transfers, it should be appreciated that the process 450 may also be used to produce searchable data elements for other types of documents.

Data regions in document images may be converted into text fields using any suitable process (e.g., OCR, manual transcription). At block 452, the text fields extracted from a document image are received. Each text field includes a text string extracted from a document image. The text fields may also be associated with a particular field type, such as grantee, recording date, legal description, or any other type of field that may be associated with the document.

At block 454, a document context is received. The document context includes a document type associated with the document image. The document type for a particular document image may have been determined using any suitable process (e.g., the process described with reference to FIG. 4B, manually, etc.). In some embodiments, a document context may be associated with a set of one or more documents having the same document type. The set of documents may be processed as a group and individually to extract searchable data elements from each document included in the group. The document context may also include processing information describing the processing steps which have been performed on one or more document(s) associated with the document context. Thus, while FIG. 4C will be described with reference to processing a single document, it should be appreciated that the process 450 may be equally applicable to a set of documents processed as a group.

In some embodiments, documents are processed through one or more document processing states. At the conclusion of each document processing state, one or more outputs are produced which advance or modify the state of the document being processed. Some document states may be processed in parallel. An initial state of document processing state may comprise the document having been processed to determine the document type and to extract the raw text fields received in block 452.

At block 456, one or more rules are obtained that are associated with the document context. By way of example, the rules may be obtained by retrieving the rules from one or more databases. The rules may specify operations that are to be performed to extract data elements from text fields or to perform other operations for a particular document processing state. A further description of the types of rules that may be obtained will be described in more detail below with reference to FIG. 4D.

The rules obtained at block 456 may be used in block 458 to process the document in the first document state. As previously mentioned, a process for a particular document state may produce outputs which advance or modify the state of the document. In some embodiments, the process applied to a document in the first state (comprising raw text fields) may include extracting one or more data elements from one more of the text fields. The extracted data elements may then be posted to a searchable database. Some embodiments may also add auditing information to the context information (or other location) detailing one or more of the operations performed to the document in block 458.

As an exemplary illustration, a document in a first state may include a text field associated with a grantee type. The text field may include the text string “Fred and Wilma Flinstone, a married couple, joint tenants with right of survivorship.” The process applied in block 458 may extract the following data elements and post the respective data element to the indicated searchable database field identifier: “Fred Flintstone” posted to a grantee field identifier; “Wilma Flintstone” posted to a grantee field identifier; “married_couple” posted to a marital_status field identifier; and “JTWROS” posted to a tenancy field identifier. As can be appreciated, the extraction process may do more than literally extract text from the text string. For example, during the extraction process the text field may be analyzed to obtain information which may then be used to create data elements (e.g., “married_couple”). The foregoing illustration is intended to be exemplary in nature only. Alternative embodiments may process the exemplary text string in a different manner and many other examples are possible.

Since the raw text fields received 452 may be highly unstructured, manual intervention may be needed to produce one or more of the outputs for a document processing state. In block 460, a determination may be made as to whether there are one or more exceptions that require manual intervention. For example, a text field associated with a date field type may be placed in a status that requires manual intervention (exception status) if a date can not be automatically extracted from the text string. Other types of exceptions may also occur.

If there are exceptions, text fields or other processing inputs associated with the exceptions(s) may be sent to an operator for resolution (block 462). In some embodiments, the exception(s) may be sent to the operator by placing the associated document in an exception state. After the operator has resolved the exception(s), the operator may advance the document to a next processing state (block 464) or may return the document to the same processing state causing the exception (block 458). Some embodiments may provide a user interface to display the documents in exception states, to receive inputs resolving exceptions, and/or to display and/or receive information related to the processing of documents.

If there are no exceptions (block 460) and/or after an operator has resolved exceptions and determined to advance to the next processing state, the process may continue at block 464. At block 464, a determination may be made as to whether the document is in an output state (processing is completed). In some aspects, the determination may be made by examining context information associated with the document. If the document is not in an output state, the process continues back at block 456 where rules are obtained that are associated with the document context and that are used to process the next state.

In some embodiments, subsequent processing state(s) may extract one or more data attributes from one or more of the data elements. One exemplary processing state may be used to extract name attributes from data elements that include names and to post those attributes to the searchable database. Posting an attribute to the searchable database may include associating the attribute to its respective data element. For exemplary purposes, in the previous illustration, the grantee data element fields from the grantee data element field “Fred Flintstone”: “Fred” posted to a first name attribute and “Flintstone” posted to a last name attribute. In another exemplary processing state, one or more data attributes may be extracted from a legal description data element. Data attributes extracted from a legal description element may include attributes such as subdivision name, lot number, block number, address, etc. It should be appreciated that there are many other types of processing states that may be applied.

In some embodiments, some of the document processing states may at least partially execute concurrently. For example, a processing state to extract name attributes may execute concurrently with a processing state to extract legal description attributes. In other aspects, document processing states may execute on different machines (perhaps concurrently). A management component of a posting engine may manage the routing of the document processing.

Once the document has reached the output state, the outputs produced from the document processing states (e.g., data elements and attributes) may be verified in block 466. The verification process may apply a process to determine a confidence that one or more of the outputs were posted correctly. Further details of a verification process are described below. If the verification process determines that one or more of the outputs may have been posted incorrectly, the document may be placed in an exception or error state until an operator can resolve the error. It should be appreciated that other embodiments may include performing additional or alternative verification processes before a document completes a processing state.

Other embodiments of a process that may be used to convert document fields into searchable data elements may include fewer, additional, or different blocks than those described above.

FIG. 4D illustrates another portion of the input process 400 in greater detail. The process 470 of FIG. 4D includes at least a portion of block 410 of FIG. 4A at which location the content of data regions is converted to searchable data. To accomplish this, the content is first converted into a text string, which may be accomplished using OCR, manual transcription, and/or the like. Thereafter, the text string is processed through the process 470.

The process 470 includes two interrelated sub-processes: a context-based sub-process and a confidence-based sub-process. Either or both of these sub-processes may be employed in any given embodiment. The context-based sub-process uses recognizable words and/or phrases within the string to parse a text string into recognizable constructs (e.g., a tenancy clause), which in some cases amounts to fully parsing the construct into individual data elements (e.g., first name, last name, ownership interest, etc.). The confidence-based sub-process uses statistics to fully parse recognizable constructs and/or correct errors such as misspellings and transcription errors.

The context-based sub-process described herein focuses upon comprehension of text within a specific domain, such as specific legal document fields. The natural language form used for specific legal document fields (e.g., grantor/grantee or a property legal description) uses frequent, repetitive phrases as well as unique, non-standard text. Reoccurring phrases may be described in a rule used to detect the phrase during parsing. For example, all forms of “tenancy” clauses (joint, not in common, etc.) can be described using BNF¹-like grammar rules. Rules may define allowed combinations of tokens and/or require specific token combinations (i.e., context). Unlike singular tokens (or patterns), which are usually too ambiguous, a rule that defines token combinations can be made sufficiently unique to avoid false positives. Rules are then employed in a rule-based matching parser, which locates the token in text strings. To decide which of several potential rule matches best represents the text, the parser implements some form of decision logic, typically favoring the longest phrase or grammar rule matched.
¹ BNF—Backus Naur Form, notation used for context-free grammars such as programming languages.

Each rule may be a hierarchy of rule productions, resulting in a potentially complex set of token sequences, where each “token” alone can be defined as either a simple token, collection of equivalent tokens (aliases), or a pattern representing a “class” of tokens, such as numbers.

Since in practice no set of rules can be sufficiently complete to cover all possible text, parsing will almost always result in some amount of unrecognized, non-standard text. Such text often represents names (either personal, entity or location), or it may represent some other information not defined by the rules.

Context-based parsing starts with top-level context recognition, where program logic recognizes patterns of constructs.² For example, specification:
<lot> <block> <subdivision><county><state>
   represents reference to a platted property location. Note that some portions of the specification may be missing or there may be some unrecognizable text.
   ² The top-level construct relationship is in fact a grammar, recognition of which could be delegated to a parser. However, presence of un-parsed text (such as names) and a high volume of optional (unused) phrases make such high level grammars too complex and often brittle (prone to miss detection due to minor deviation from anticipated form).

Once the top-level context has been determined, each construct is subject to construct-specific analysis. At this point, the program logic retrieves the construct specific data. This may be either the construct meaning (such as the “tenancy” types mentioned earlier), or additional, often numeric information (lot, block numbers/identifiers, book/page references, distances and bearings etc.). In both cases, the parser result (a parse tree) is traversed by program logic corresponding to each recognized construct, finding required information and converting it into data.

Recognized constructs (tokens and/or phrases) further provide context for the unparsed text. For example, a phrase “husband and wife” will typically follow a pair of personal names. Also, a grammar rule for a specific document field may describe phrases that have no meaning for document processing, but their recognition eliminates the “unknown” from the text.

Analysis of text not covered by a rule depends upon the context, given by the document field type and the surrounding, recognized phrases. Unlike recognized phrases, this analysis may yield a low confidence and thus require operator intervention. Unparsed text (i.e., text for which no rule exists) is typically analyzed as: names (persons, entities, locations etc.); frequent token co-locations (open-loop feedback input); or noise (unprocessed, ignorable text).

Names analysis leverages the formal rules for names (such as capitalization) as well as statistical information about known names (both for personal names, legal entity names, or locations).

Frequent token co-location captures tokens, which are not expected or not likely to be names, along with their relative location with respect to other tokens or recognized phrases (token combination frequency). As a result, the token is either automatically ignored as noise, input into the grammar definition/refinement process, or sent to manual review. Certain token co-locations may be pre-identified as known “noise”. All co-locations may be subject to frequency based feedback analysis, which may be either automatic, or manual (for example, if a given token pair is seen 1000 times in lower case and never in “proper” case, it may be automatically categorized as “noise” in the context of name lookup).

Noise is analyzed for volume and other characteristics (e.g., the presence of numbers, specific token classes, and the like). The analysis decides to either ignore the noise or some portion of it or to submit the noise token to manual review.

When required, manual review is performed by an operator. Often, the operator is simply aiding automated process by correcting miss spelling, removing redundant, unnecessary text, or otherwise correcting the phrase.

The confidence-based sub-process solves a problem inherent to known parsers, which require an exact match at the token level, matching either a specific token, pattern or a token “class”. As a result, the parser either can not deal with cases where the “class” may be uncertain, or it fails to match complete phrases because of a minor misspelling—a “brittle” rule. For example, a rule requiring “tenants in common” will fail to match “tennants in comon” unless the grammar anticipated both misspellings.

An example of “uncertain” token rating is parsing of personal names. Some name tokens, such as “John” or “Brown” can be relatively safely rated as “first” and “last”. However, token “Thomas” may be either “first” or “last” name³.
³ According to US Census data, the frequency of the name “Thomas” as either first or last name is very comparable

Embodiments of the present invention solve the problem by replacing “exact” matches (true/false) by match “confidence”, i.e. rating expressing the match quality. This “confidence” is first applied at the token match level, and then propagated up to the phrase level: at each grammar tree level, the “confidence” is computed by taking into account both the assigned “confidence” or relative “weight” of a given rule (as compared to other possible rules at that level), and combined confidences of its constituent (either rules or tokens).

The parser examines possible matches, ultimately rejecting matches yielding a low confidence. The parser can also use an ambiguity threshold, reporting any cases where a given text can match multiple grammar rules resulting in a similar confidence as “ambiguous”, thus flagging the text for resolution by a human operator.

The “confidence” computation can include both the rating of the immediate members (productions) of a given rule, and a contribution (influence) of other (nearby) rules. For example, a grammar for decoding a 4-token name such as “Mary Allison Scott Brown” can favor a breakdown into two 2-token names (Mary Allison, Scott Brown) if the parsed text also includes a “hint” suggesting two names, such as “tenants”. Further, a “sub-phrase” confidence can take into account the cases where a “sub-phrase” provides a close match to multiple grammar rules; the rating assigned to each such “match” may be lowered to account for the uncertainty (ambiguity).

The “confidence” based technique applies very well to potentially misspelled text, such as the one resulting from document OCR, where individual characters may be misinterpreted (e.g., capital “O” versus zero, “m” interpreted as “m” etc), or where the white space separating words may be either missing or added (breaking a token into two). At an individual token match level, the “confidence” is simply a measure of how well the token matches the expected one. At a phrase level, lowered confidence in one or more phrase token(s) can be well compensated for by the complete phrase context—unless there is a “similar” match to a different phrase.

Having described the context-based and confidence-based sub-processes generally, attention is redirected to FIG. 4D. As previously described, at block 410 text from data regions of documents is parsed into searchable data elements. For example, a text string representing a legal description may include a state, a county, a subdivision, and/or a lot. It also may include a reference to a recorded subdivision plat or other recorded documents. Such is the case with respect to the legal description 310 on the mortgage document of FIG. 3A. This legal description refers to Lot 22 of the Hickory Acres subdivision in St. Johns County, Florida. The subdivision plat is recorded in plat book 15 at pages 90 and 91. The legal description also refers to a deed transferring the parcel from Patricia J. Sellers to William and Victoria Sellers. The deed is recorded at Book 1091, Page 1485, St. Johns County, Florida. The deed is the Warranty Deed of FIG. 3B. The Warranty Deed includes a text string 320 representing the property transfer and includes a grantor name, a grantee name, a grantor address, and a grantee address, among other things. To create a searchable property records database, text strings such as these must be parsed into individual data elements and posted accordingly.

Hence, the process 470 begins at block 472 at which point a text string is received for analysis. The text string relates to a data region of a particular document. The text string may have been produced in any of a number of ways. For example, the text string may have been converted from an image of the data region by an OCR process or may have been received from another type of process. In another example, the text string may have been created by an individual transcribing an image of the data region into the text string. In some cases, the text string was created from a combination of the foregoing.

In some embodiments, the text string may be one of a plurality of text strings grouped together for batch processing through the ensuing process. For example, when a large group of recorded documents for a specific county are processed together, a number of documents (e.g., all the warranty deeds) may have a common data field (e.g., a legal description). All the data fields representing legal descriptions from warranty deeds may be queued together for batch processing, which may increase the efficiency of the process.

In some embodiments, each text string is “tagged” with information that identifies the type of document and specific data field of the string. This allows different types of text strings to be processed differently. For example, legal descriptions from warranty deeds may be processed differently from mortgagee clauses from a mortgage document.

At block 474, the process is initialized by loading data from one or more databases 475. Initialization may include, for example, inputting a list of subdivision names in the county. The list may include a range of lot numbers for the subdivision, various permutations of the subdivision name, the original recording date of the subdivision, and the like. As will become clear from the ensuing description, initializing the process with such information improves the efficiency of the process, among other things. Using a list of subdivision names allows the name to be picked out of a text string. The presence of a subdivision name signals that the string should also include a lot number. The lot number should be in the range for the subdivision, and the data of the document should be later in time than the recording date of the subdivision plat. Hence, from merely initializing the process with a list of subdivision names, a large percentage of the text strings may be easily parsed. In addition to increasing efficiency, initializing the process also may improve the quality (i.e., the reliability) of the final product and the success ratio or yield of the process. In fact, the process may not even be possible with some degree of initialization.

Initialization also may include inputting grammar rules. Grammar rules are rules used to parse text strings. Grammar rules typically consist of the rules by which the “tokens” are recognized (i.e. known words, dates, patterns) and of the rules defining the valid (known, recognized) token aggregations (phrases). Grammar rules may include, for example, common misspellings, recognizable token combinations (i.e., text substrings), date formats, and the like. A feedback loop adds grammar rules in an effort to continuously improve the efficiency of the process.

At block 476, a text string is initially parsed. Using grammar rules and other initialization information, a text string is parsed into unknown text and recognized constructs. For example, recognizable constructs may include tenancy clauses, common legal description formats (e.g., “lot ______, block ______”), and the like. Unknown text may include noise (words that have no particular significance in the string), misspelled words, unknown words, and the like.

At block 478, recognized constructs are further analyzed. While every word in a recognized construct may not be immediately known, context may allow the construct to be completely parsed into data elements and/or known constructs. The presence of specific tokens and/or phrases within a construct often provides clues to the meaning of those tokens that are not recognized. For example, the phrase “husband and wife” typically is preceded by a pair of personal names. In a specific embodiment, analyzing recognized constructs comprises creating a parse tree and traversing the parse tree using program logic corresponding to the recognized construct. By doing so, specific words within the construct are identified for their specific meaning.

In some embodiments, an attempt is made to identify data elements within a recognized construct, thereby bypassing the ensuing confidence-based process described immediately hereinafter. In other embodiments, however, unknown text is passed to block 480 while known constructs are passed to block 484.

At block 480, statistical rules are applied in an attempt to classify unknown text strings into categories. Categories may include, for example, “name”, “address”, and the like. Unrecognized tokens and/or phrases assigned to a category may include one or more data elements (e.g., first name, last name). Hence, block 480 may produce categorized tokens and noise. Noise includes individual words and/or text strings whose meanings cannot be determined by context-based rules. Categorized tokens include tokens which are not known constructs but which, based on contextual rules, appear to relate to particular data elements.

The statistical rules are compiled at block 482 and may include a wide variety of statistically-based rules. For example, rules may relate to whether words are capitalized. Those who prepare documents (e.g., clerks at title companies and mortgage companies) do not necessarily follow consistent procedures with respect to capitalization, although information may be gained by observing the frequency with which certain words are capitalized. Hence, statistical rules are created to assist with classifying text into categories based on whether the text is capitalized. Many other examples are possible.

Compiling statistical rules is an ongoing process. For example, in a batch process in which many text strings from a similar data field are processed, the occurrence of a phrase or word at a significant frequency may trigger a statistically-based rule that increases the efficiency of the process. As a specific example, a rule may dictate that a phrase that includes the word “acres” should be categorized as a subdivision name (e.g., “Green Acres”) if “acres” is not preceded by a number but otherwise should be categorized as a legal description (e.g., “the north 40 acres of . . . ”).

As is clear from the method illustration, various feedback loops allow the process to be improved. For example, in a batch run of many text strings, if a significant number of text strings cannot be fully parsed due to the presence of an unknown word, it may be the case that the unknown word is a subdivision name that was not included in the initialization list of subdivision names. The name may be added to the initialization list and the batch re-run. Hence, previously unparsable text strings may thereafter be parsable. Another example of a feedback analysis is the “subdivision name feedback” in which case the parser can determine a context where a phrase could/should represent a subdivision name, but the phrase did not match any known subdivision names. The frequency of such name phrases may be recorded, and, upon the occurrence of a threshold frequency, such name phrases may be identified as a “subdivision alias.”

Block 484 begins the confidence-based parsing process, which may be applied independently of the context-based process in some embodiments. In other words, either or both process may be used to convert a text string to data elements that are thereafter posted to a searchable database. The process begins by receiving noise, categorized tokens and known constructs from the context based process. These items may be commonly referred to as “Pseudo Tokens.” Although the confidence-based process will be described hereinafter as if it logically follows the context-based process, it should be recognized that the process may begin by receiving an unparsed text strings.

At block 488, tokens are parsed using confidence-based rules compiled and maintained at a rules database 490. Confidence-based rules may correct common misspellings, distinguish first names from last names, correct OCR errors, and the like. For example, a rule may identify a proper name as being most likely a first name as opposed to a last name. The information that helps to make that determination may come from a source of census information or the like. As another example, a word common to legal descriptions also may be commonly misread by an OCR process. For example, an OCR process may misread the word “plat” as “piat.” While “piat” may be a person's name, a city or street name or the like, a rule may state that 80% of the time “piat” should be “plat.” Another rule might state that if “piat” is immediately preceded by “recorded,” 99% of the time it should be “plat.” In some cases, multiple rules may be applied to specific pseudo tokens and the rule that produces the highest confidence may determine how the token or phrase is parsed.

In some embodiments, a threshold value is chosen for determining when a rule should be followed. For example, if the degree of match between a token or portion of a token exceeds 70%, then the rule should be applied. The threshold may be user configurable. For example, assume that a batch run of 1000 documents produces 150 exceptions that must be manually corrected when the confidence threshold is set at 70%. The user may reduce the threshold to 60% for the exceptions and re-run the exceptions through the process to see if a lower threshold resolves the exceptions.

At block 492, individual words or phrases are coupled to data elements. Exceptions are passed to an operator for manual correction at block 494, while successful couplings are passed to block 496 for posting to the database. Exceptions may include, for example, lot numbers out of range of a recorded subdivision map, tokens that appear to be subdivision names that are not in the list of subdivision names used to initialize the process, references to recorded documents that do not exist, and the like.

At block 494, an operator may assign words and/or phrases to data elements and forward the result to block 496 for posting. In some embodiments, however, obvious mistakes (misspellings OCR errors, etc.) are corrected and the string is reintroduced into the process for further automated processing. In some cases, the most frequent operator correction is removal of some noise, text that is irrelevant to the required information (e.g., is not a name), but could not be safely eliminated by the process, for example, because either this text is a new, unknown phrase or that the categorization is too ambiguous. In the specific example described herein, the string is reintroduced at block 496 for initial, context-based parsing. In other embodiments, the string is reintroduced into the process at a different location.

At block 496, individual words and/or phrases are posted to specific data elements. For example, last names are posted to Last_Name data elements, first names to First_Name data elements, individual address components (city, state, zip code, etc.) are posted to respective address data elements, and so on. The data elements are then stored for later recall in response to specific search requests.

It is to be understood that the data input method 400 is but one example of a process for reducing recorded documents to searchable data. Other such methods may include more, fewer, or different operations. Further, the operations described herein may be performed in different orders than just described. Those skilled in the art will recognize a number of such possibilities in light of this disclosure.

Attention is directed to FIGS. 5A-5F, which illustrate exemplary output documents according to embodiments of the invention. Exemplary electronic output is illustrated in FIGS. 6B, 6C, and 6F. FIG. 5A illustrates a first section of an exemplary title abstract. This exemplary section includes Vesting Deed Information and Legal Description(s) of Subject Property. FIG. 5B illustrates a second exemplary section of a title abstract. In some embodiments, the title abstract includes all data needed by an examiner to underwrite a policy or loan using commonly-accepted underwriting rules. Thus, the examiner need not refer to the source documents to complete the underwriting process.

The abstract may include a list of relevant documents. In some embodiments, this list contains only enough information for a searcher to locate documents manually. The list may include a relevance score, which may be determined in any of a number of ways. For example, documents having an address that correlates perfectly with the parcel may be considered highly relevant, while documents having the same grantee but a different property address may be considered less so. Many other examples exist. A document's relevance may be expressed as a percentage and ranked accordingly on the output document. Those skilled in the art will recognize other possibilities in light of this disclosure.

Additionally, the title abstract may include a score, grade, or exceptions list that provides an indication of the quality of the title as it relates to the marketability of the property it represents. In other words, parcels with “clean” titles will have more favorable scores. The score could be used to approve a loan, commit to a loan, determine settlement fees and/or closing costs associated with closing a loan, and/or the like. A title score may be calculated in any of a number of ways using a variety of factors. For example, factors may include: the number and types of documents relating to the parcel; the presence of judgments, tax liens, lis pendens, and/or the like; chain of title breaks; unusual vesting and/or ownership conditions; insurance claims history; and the like. Each of these factors may include conditions within. For example, with respect to the number and types of documents relating to the parcel, additional considerations may include: unreleased encumbrances; modified or assigned encumbrances; and the like. With respect to judgments, tax liens and lis pendens, consideration may be given to whether these encumbrances are within the statute of limitations for the particular jurisdiction for that type of judgment. Breaks in a chain of title may be reconciled with other documents such as divorce decrees, death certificates, and the like. Many other examples are possible and apparent to those skilled in the art in light of this disclosure.

With respect to calculating the actual score based on the foregoing factors, many possibilities exist. For example, each of the various factors and sub-factors may receive a particular weighting, and the presence or absence of particular conditions may be combined with the weighting to determine the final score. As another example, any of a number of conditions may receive a value, and the values for all conditions may be combined to arrive at the score or detract from an ideal score. Many such possibilities exist and are apparent to those skilled in the art in light of this disclosure. In some examples the title score is a title grade, such as a letter grade. In some embodiments, the summary is a list of exceptions such as unreleased liens and mortgages, unresolved judgments, and the like.

FIG. 5C illustrates a first page of a commitment that may be produced according to some embodiments. FIG. 5D illustrates a second page that includes conditions that must be met before a policy will be issued based on the commitment. FIGS. 5C and 5D illustrate a commitment for an owner's policy in the amount of $225,000. Thus, a mortgage company may obtain a title commitment electronically merely by requesting one via the Internet. The title commitment illustrates in FIGS. 5C and D may be automatically produced, in some embodiments, following a process of automated title examination, wherein business rules are used to accomplish the process previously performed manually. Title policies and other such documents may be generated similarly.

FIGS. 5E and 5F illustrate two pages from a policy that may be produced according to some embodiments. These pages represent a lender's policy. FIG. 5E illustrates Schedule A, which includes the basic policy information; FIG. 5F illustrates Schedule B, which includes the Exceptions from Coverage.

Attention is directed to FIGS. 6A-6F, which illustrate a series of display screens that a user may view in the process of interacting with the system described herein. These display screens are merely exemplary, as will be appreciated by those skilled in the art. The display screens may be produced by the network interface 116 of FIG. 1, which may be, for example, a web server. The screens then may be viewed using browser software residing on a user device, such as a personal computer, as is known in the art. FIG. 6A illustrates a request screen through which a user may request a title search. The screen includes data fields for names, address, county and state. A Search by drop down menu may be used to select from a number of different search methods, including: address; legal description; source document; and the like. Some of these fields may be required fields, while others may be optional. The user completes the required fields and any of the optional fields the user desires to complete. The screen also may include fields for requesting the type of output the user desires. For example, the user may desire a document list, a title abstract, a title policy, and/or the like. Additionally, the user may desire to have a relevance associated with each document and may desire a marketability score or grade for a parcel. Once all the fields are complete, the user may submit the request by selecting the search button.

Those skilled in the art will appreciate that other examples according to embodiments of the invention may have the fields on different display screens. Other examples may use more or fewer screens and fields. For example, other display screens may include payment fields, account setup and management fields and the like. Many variations are possible.

FIG. 6B illustrates an exemplary document list display screen that may be returned to the user. This list includes documents identified in the search. The list may be color coded to provide the user with additional information as more fully explained in previously-incorporated U.S. patent application Ser. No. 10/804,464, entitled “DOCUMENT ORGANIZATION AND FORMATTING FOR DISPLAY” (Attorney Docket No. 040143-000400). The list may include a relevance score for each document as previously described. The list may include hyperlinks or buttons for requesting more detailed information about the identified documents, including an image of the document. Many other examples are possible.

FIG. 6C illustrates an exemplary document summary screen according to an embodiment of the invention. The document summary screen includes relevant information from a selected document.

FIGS. 6D and 6E illustrate first and second portions of an options screen that may be used to define the type of output the user desires.

FIG. 6F illustrates a title abstract display screen according to embodiments of the invention. The title abstract may include a marketability score or grade as previously described. Using the abstract, an examiner may underwrite a policy without reference to the source documents from which the abstract was generated.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to real property records searching specifically or property records searching generally. For example, the present invention may be used to search corporate filings, license records, and the like. Accordingly, the above description should not be taken as limiting the scope of the invention, which is defined in the following claims.

1. A method of populating a database, comprising:
receiving a plurality of document images;
defining a plurality of standard document types;
mapping each of the plurality of document images to one of the plurality of standard document types;
processing each document image through a data extraction process, wherein a specific document image's path through the data extraction process is based, at least in part, on the mapping, wherein the data extraction process posts data from each document to the database;
receiving a request from a user for data contained in the database;
selecting the data using the request; and
displaying the selected data to the user.

2. The method of claim 1, wherein the document images relate to recorded documents relating to property transfers.

3. The method of claim 1, wherein defining a plurality of standard document types comprises:
identifying data fields to be captured during the data extraction process;
determining how data extracted from a document image relating to the document type will be selected during the selecting step; and
determining how the data extracted from a document relating to the document type will be displayed during the displaying step.

4. The method of claim 1, wherein mapping each of the plurality of document images to one of the plurality of standard document types comprises:
receiving an index of recorded documents relating to the plurality of document images;
using the index and the standard document types to create a mapping table; and
using the mapping table to assign a temporary standard document type to the document images.

5. The method of claim 4, further comprising using optical character recognition performed on one or more document images to confirm the temporary standard document type assignment.

6. The method of claim 4, further comprising using pattern recognition performed on one or more document images to confirm the temporary standard document type assignment.

7. The method of claim 4, further comprising using a combination of optical character recognition and pattern recognition performed on one or more document images to confirm the temporary standard document type assignment.

8. A system for populating a database, comprising:
a computing system having a processor and memory; and
instructions maintained on the memory and executable by the processor to:
receive a plurality of document images;
map each of the plurality of document images to one of a plurality of standard document types;
process each document image through a data extraction process, wherein a specific document image's path through the data extraction process is based, at least in part, on the mapping, wherein the data extraction process posts data from each document to the database; and
in response to a request for data from the database, select the requested data and send it to a user.

9. The system of claim 8, wherein the document images relate to recorded documents relating to property transfers.

10. The system of claim 8, wherein the instructions maintained on the memory and executable by the processor to map each of the plurality of document images to one of the plurality of standard document types include instructions to:
use a mapping table that maps document types listed in an index of recorded documents to the standard document types to assign a temporary standard document type to the document images.

11. The system of claim 10, wherein the instructions maintained on the memory and executable by the processor to map each of the plurality of document images to one of the plurality of standard document types further include instructions to use optical character recognition performed on one or more document images to confirm the temporary standard document type assignment.

12. The system of claim 10, wherein the instructions maintained on the memory and executable by the processor to map each of the plurality of document images to one of the plurality of standard document types further include instructions to use pattern recognition performed on one or more document images to confirm the temporary standard document type assignment.

13. The system of claim 10, wherein the instructions maintained on the memory and executable by the processor to map each of the plurality of document images to one of the plurality of standard document types further include instructions to use a combination of optical character recognition and pattern recognition performed on one or more document images to confirm the temporary standard document type assignment.

14. A computer-readable medium having maintained thereon computer-executable instructions to program a computer to:
receive a plurality of document images;
map each of the plurality of document images to one of a plurality of standard document types;
process each document image through a data extraction process, wherein a specific document image's path through the data extraction process is based, at least in part, on the mapping, wherein the data extraction process posts data from each document to the database; and
in response to a request for data from the database, select the requested data and send it to a user.

15. The computer-readable medium of claim 14, wherein the document images relate to recorded documents relating to property transfers.

16. The computer-readable medium of claim 14, wherein the instructions to map each of the plurality of document images to one of the plurality of standard document types include instructions to use a mapping table that maps documents types listed in an index of recorded documents to the standard document types to assign a temporary standard document type to the document images.

17. The computer-readable medium of claim 16, wherein the instructions to map each of the plurality of document images to one of the plurality of standard document types further include instructions to use optical character recognition performed on one or more document images to confirm the temporary standard document type assignment.

18. The computer-readable medium of claim 16, wherein the instructions to map each of the plurality of document images to one of the plurality of standard document types further include instructions to use pattern recognition performed on one or more document images to confirm the temporary standard document type assignment.

19. The computer-readable medium of claim 16, wherein the instructions to map each of the plurality of document images to one of the plurality of standard document types further include instructions to use a combination of optical character recognition and pattern recognition performed on one or more document images to confirm the temporary standard document type assignment.
